(19) United States
(12) Patent Application Publication
(10) Pub. No.: US 2025/0243702 A1
(43) Pub. Date: Jul. 31, 2025

(54) HUNTING BLIND WITH INCONSPICUOUSLY OPERABLE WINDOWS

(71) Applicant: Horizon Pursuit, LLC, St. Charles, KY (US)

(72) Inventor: Nathan J. Schlabach, St. Charles, KY (US)

(21) Appl. No.: 19/031,306

(22) Filed: Jan. 17, 2025

Related U.S. Application Data
(60) Provisional application No. 63/625,372, filed on Jan. 26, 2024.

(51) Int. Cl. E05F 11/48; A01M 31/02; E05D 13/00; E05F 7/04

(52) U.S. Cl. CPC E05F 11/48; A01M 31/025; E05D 13/14; E05F 7/04; E05Y 2201/668; E05Y 2600/626; E05Y 2900/148

(57) ABSTRACT

A hunting blind with inconspicuously operable windows includes a wall panel; a shelf connected to the wall panel; a window frame in the wall panel above the shelf; a window sash movably received in the window frame; at least one pulley connected to the wall panel; a sash cord disposed about the at least one pulley, the sash cord having a first end and a second end, the first end connected to the window sash; and a counterweight having a top connected to the second end of the sash cord and a bottom extending below the shelf, the counterweight configured to be manually operable from underneath the shelf to move the window sash in the window frame while user movement during operation of the counterweight is substantially concealed from game.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### CROSS-REFERENCES TO RELATED APPLICATIONS

This non-provisional patent application claims priority to U.S. Provisional Patent Application Ser. No. 63/625,372, filed Jan. 26, 2024 and titled “HUNTING BLIND WITH SASH WINDOWS,” the entire disclosure of which is hereby incorporated by reference.

### STATEMENT REGARDING FEDERALLY SPONSORED RESEARCH OR DEVELOPMENT

Not Applicable.

### REFERENCE TO SEQUENCE LISTING OR COMPUTER PROGRAM LISTING APPENDIX

Not Applicable.

### BACKGROUND OF THE INVENTION

The present disclosure relates generally to the field of hunting. More specifically, the present disclosure relates to hunting blinds with movable windows.

A hunting blind is a concealment device for hunters that is designed to reduce the chance of detection by game animals. Many different types of blinds are known, including both mobile and stable ground blinds, elevated blinds, and tree stands, among others. Some are exceedingly simple, while others are complex. Some hunting blinds are designed to facilitate hunting of a single type of game animal, such as big game (e.g., elk, white-tailed deer) or waterfowl (e.g., ducks and geese), while others are designed to be used in hunting multiple different types of game across different environments.

More complex and comfortable modern blinds tend to include multiple walls, a roof, and a floor that collectively define an enclosure in which a hunter can wait for game while shielded from the elements. A door defined through one of the walls allows the hunter to enter and exit the enclosure as desired, while one or more open slots or moveable windows defined in one or more of the walls permit the hunter to view his or her surroundings and shoot at game from concealment. Hunting blinds with movable windows are far more comfortable than blinds with simple open slots at least in part because the windows retain more heat within the enclosure and block more wind than open slots.

However, a hunter's body movement while opening traditional windows (e.g., by lifting upward with one or both hands) can scare game away by alerting the game to the presence of the hunter. Additionally, sliding open a traditional window inside a window frame also causes a distinctly unnatural noise that rings surprisingly loudly in natural environments, which can likewise scare game away and deter game from approaching the area of the hunting blind.

Accordingly, what is needed are improvements in hunting blinds.

### BRIEF SUMMARY

This Brief Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Features of the presently disclosed invention overcome or minimize some or all of the identified deficiencies of the prior art, as will become evident to those of ordinary skill in the art after a study of the information presented in this document.

It is an object of the present invention to provide a hunting blind with inconspicuously operable windows that can be silently opened and closed using only one hand while all user movement during operation of the window is concealed from game. Each window includes a counterbalanced pulley system that connects a paned window sash to an exposed counterweight that can be uniquely mounted to a shelf underneath the window for quick and easy manual operation while the user sits comfortably concealed within the blind. In operation, a user manually grasps a bottom portion of the counterweight underneath the shelf and lowers or raises the counterweight to respectively raise or lower the window. The shelf can reliably conceal user hand and arm movement from even airborne game. In some embodiments, silent operation of the windows can be achieved via strips of a sound damping and vibration absorbing material lining tracks in the window frame that significantly reduce the sound emitted by raising and lowering the window sash in the window frame.

Accordingly, in one aspect, the invention provide a hunting blind, comprising a wall panel; a shelf connected to the wall panel; a window frame on the wall panel above the shelf; a window sash movably received in the window frame; at least one pulley connected to the wall panel; a sash cord disposed about the at least one pulley, the sash cord having a first end and a second end, the first end connected to the window sash; and a counterweight having a top connected to the second end of the sash cord and a bottom extending below the shelf, the counterweight configured to be manually operable from underneath the shelf to move the window sash in the window frame while user movement during operation of the counterweight is substantially concealed from game.

In another aspect, the invention provides a hunting blind comprising a wall panel; a shelf connected to the wall; a window frame on the wall panel above the shelf; a vertically movable window sash slidably received in the window frame; a pane of translucent or transparent material secured in the window sash; at least one pulley connected to the wall above the window frame; a sash cord disposed about the at least one pulley, the sash cord having a first end and a second end, the first end connected to the window sash; and a counterweight extending through the shelf, the counterweight having a top connected to the second end of the sash cord and a bottom extending underneath the shelf, the counterweight configured to be manually movable down and up to respectively raise and lower the window sash in the window frame while user movement during operation of the counterweight is substantially concealed from game visible to the user through the pane.

In yet another aspect, the invention provides a hunting blind comprising a wall panel; a guide tube connected to the wall panel; a window frame on the wall panel proximate the guide tube; a vertically movable window sash slidably received in the window frame; a pair of laterally spaced pulleys connected to the wall above the window frame; a sash cord disposed about the pair of laterally spaced pulleys, the sash cord having a first end and a second end, the first end connected to the window sash; and a counterweight slidably received in the guide tube, the counterweight having a top connected to the second end of the sash cord and a bottom extending underneath the guide tube, the counterweight configured to be manually slidable down and up through the guide tube to respectively raise and lower the window sash in the window frame while user movement during operation of the counterweight is substantially concealed from game.

Numerous other objects, advantages and features of the present disclosure will be readily apparent to those of skill in the art upon a review of the following drawings and description of exemplary embodiments.

### BRIEF DESCRIPTION OF THE SEVERAL VIEWS OF THE DRAWINGS

Non-limiting and non-exhaustive embodiments are described with reference to the following figures, wherein like reference numerals refer to like parts throughout the various drawings unless otherwise specified. In the drawings, not all reference numbers are included in each drawing, for the sake of clarity.

FIG. 1 is a perspective view of a hunting blind with inconspicuously operable windows formed in accordance with an embodiment of the present invention.

FIG. 2 is an elevated perspective view of a hunter seated inside the hunting blind of FIG. 1 manually opening an inconspicuously operable window. The right window is shown in a partially open position. The left window is shown in a closed position. Arrows indicate the respective directions of movement of the counterweight and the window sash during opening.

FIG. 3 is a perspective interior view of the window of FIG. 2 with the window shown in a closed position.

FIG. 4 is another perspective view of the window of FIG. 3 showing the counterweighted pulley system and cabling arrangement in greater detail.

FIG. 5 is a magnified perspective view of the pulleys of FIG. 4.

FIG. 6 is a magnified perspective view of the window of FIG. 3 showing portions of the window frame, window sash, and counterweight in greater detail.

FIG. 7 a side perspective view of the window of FIG. 3 showing the shelf, mounting bracket, and counterweight in more detail.

FIG. 8 is an elevated right side perspective view of the mounting bracket of FIG. 7.

FIG. 9 is an elevated left side perspective view of another embodiment of the mounting bracket of FIG. 8.

FIG. 10 is a left side view of the mounting bracket of FIG. 9.

FIG. 11 is a perspective view of a pulley of FIG. 5.

FIG. 12 is a side view of the pulley of FIG. 11.

FIG. 13 is a front elevational view of the window sash of the window of FIG. 3.

FIG. 14 is a top view of the window sash of FIG. 13.

FIG. 15 is side view of the window sash of FIG. 13.

### DETAILED DESCRIPTION

The details of one or more embodiments of the present invention are set forth in this document. Modifications to embodiments described in this document, and other embodiments, will be evident to those of ordinary skill in the art after a study of the information provided herein. The information provided in this document, and particularly the specific details of the described exemplary embodiment(s), is provided primarily for clearness of understanding and no unnecessary limitations are to be understood therefrom. In case of conflict, the specification of this document, including definitions, will control.

While the making and using of various embodiments of the present invention are discussed in detail below, it should be appreciated that the present invention provides many applicable inventive concepts that are embodied in a wide variety of specific contexts. The specific embodiments discussed herein are merely illustrative of specific ways to make and use the invention and do not delimit the scope of the invention. Those of ordinary skill in the art will recognize numerous equivalents to the specific apparatus and methods described herein. Such equivalents are considered to be within the scope of this invention and are covered by the claims.

While the terms used herein are believed to be well understood by one of ordinary skill in the art, a number of terms are defined below to facilitate the understanding of the embodiments described herein. Unless defined otherwise, all technical and scientific terms used herein have the same meaning as commonly understood by one of ordinary skill in the art to which the subject matter disclosed herein belongs. The terms defined herein have meanings as commonly understood by a person of ordinary skill in the areas relevant to the present invention. Terms such as “a,” “an,” and “the” are not intended to refer to only a singular entity, but rather include the general class of which a specific example may be used for illustration. The terminology herein is used to describe specific embodiments of the invention, but their usage does not delimit the invention, except as set forth in the claims.

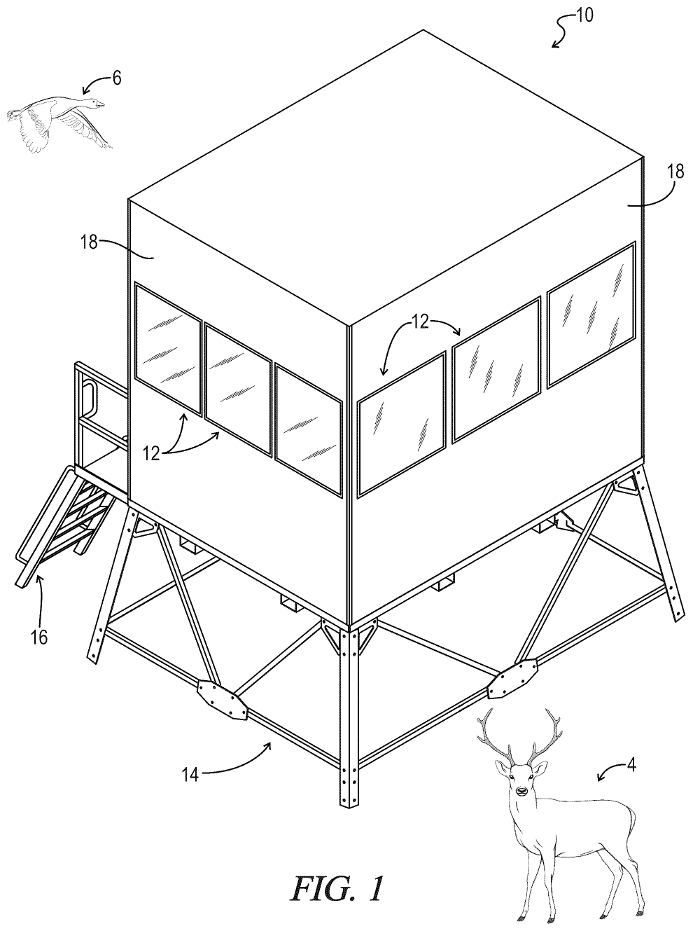

As described herein, an “upright” position is considered to be the position of apparatus components while in proper operation or in a natural resting position as described and shown herein, for example, in FIG. 1. For example, the upright firing position of a firearm is a generally level firing position. “Vertical,” “horizontal,” “above,” “below,” “side,” “top,” “bottom,” “upper,” “lower,” and other orientation terms are described with respect to this upright position during operation, unless otherwise specified, and are used to provide an orientation of embodiments of the invention to allow for proper description of example embodiments. A person of skill in the art will recognize, however, that the apparatus can assume different orientations when in use.

The term “when” is used to specify orientation for relative positions of components, not as a temporal limitation of the claims or apparatus described and claimed herein unless otherwise specified.

The terms “above”, “below”, “over”, and “under” mean “having an elevation or vertical height greater or lesser than” and are not intended to imply that one object or component is directly over or under another object or component.

The phrase “in one embodiment,” as used herein does not necessarily refer to the same embodiment, although it may. Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments.

All measurements should be understood as being modified by the term “about” regardless of whether the word “about” precedes a given measurement.

The term “substantially” as used herein and unless otherwise specifically defined elsewhere means what is considered normal, customary, or possible within the limits of applicable industry-accepted practices and manufacturing tolerances.

All references to singular characteristics or limitations of the present disclosure shall include the corresponding plural characteristic(s) or limitation(s) and vice versa, unless otherwise specified or clearly implied to the contrary by the context in which the reference is made.

All combinations of method or process steps as used herein can be performed in any order, unless otherwise specified or clearly implied to the contrary by the context in which the referenced combination is made.

The methods and devices disclosed herein, including components thereof, can comprise, consist of, or consist essentially of the essential elements and limitations of the embodiments described herein, as well as any additional or optional components or limitations described herein or otherwise useful.

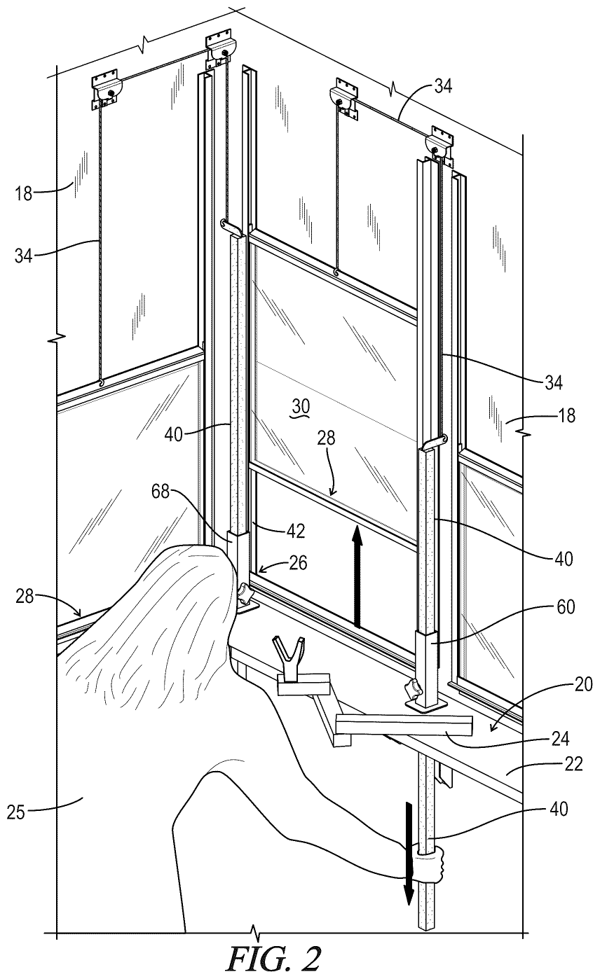

Referring initially to FIGS. 1-2, there is shown an embodiment of a hunting blind 10 with inconspicuously operable windows 12 formed in accordance with an embodiment of the present invention. Although the hunting blind 10 is depicted as supported by a tower 14 with a ladder 16 leading to a door (not visible), it is to be understood that the tower 14 and ladder 16 form no part of invention disclosed herein and that the tower 14 and ladder 16 are not required for operation of the windows 12 to be inconspicuous. To be clear, an elevated hunting blind can provide a better vantage point for a user or hunter in certain situations, but blind elevation is unnecessary for inconspicuous operation of the windows 12. In different embodiments, the hunting blind 10 can be ground based, elevated, mobile, or stable. It is also to be understood that the hunting blinds 10 with inconspicuously operable windows 12 disclosed herein can be used to hunt a wide variety of game animals including, but not limited to, land-based game 4 as well as airborne game 6. Various environments and scenarios in which the disclosed hunting blinds 10 can be successfully deployed will be readily apparent to ordinarily skilled artisans.

Referring again to FIGS. 1-2, the hunting blind 10 includes a plurality of wall panels 18, a roof (not shown) and a floor (not shown). The wall panels 18, roof, and floor collectively define an enclosure 20 in which a hunter 25 can sit concealed while waiting for game. The hunting blind 10 can also include one or more shelves 22 secured to at least one of the wall panels 18 inside of the enclosure 20. The hunter 25 can rest various objects such as firearms or animal calls on, and optionally attach a firearm mount 24 to, each shelf 22. The hunting blind 10 further includes one or more inconspicuously operable windows 12, each which forms an independently operable window system that, in combination with the shelves 22, allows the hunter 25 to inconspicuously and, in some cases, even imperceptibly open and close each window 12 without scaring game away or otherwise alerting game to the presence of the hunter 25. As explained in more detail below, each window 12 with shelf 22 is configured to hide the body movement of the hunter 25 and minimize or eliminate the sound of the window moving while the hunter 25 operates the window 12. This in turn ensures that game cannot see the hunter 25 and does not hear anything alarming or unnatural while the hunter opens a window 12 to shoot at the game therethrough. In some embodiments, one or more wall panels 18 of the enclosure 20 can host multiple windows 12 therein. The wall panels 18 and each shelf 22 can comprise any desired material, such as wood, metal, and/or plastic.

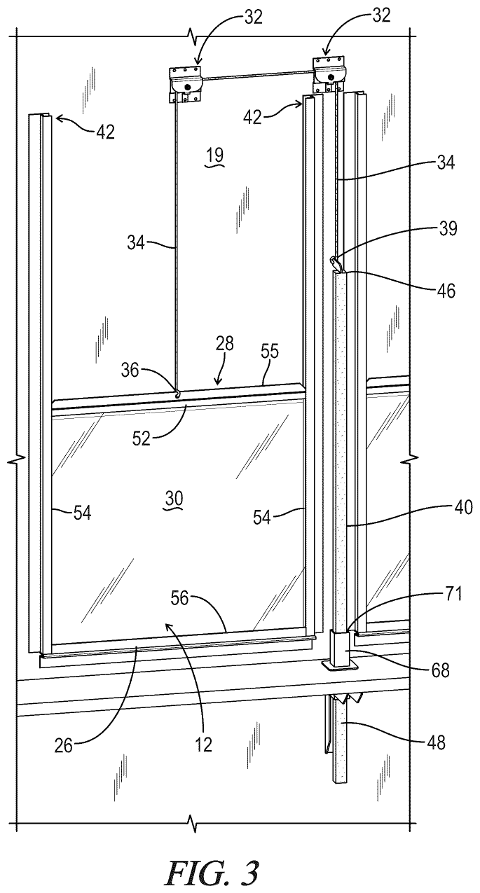

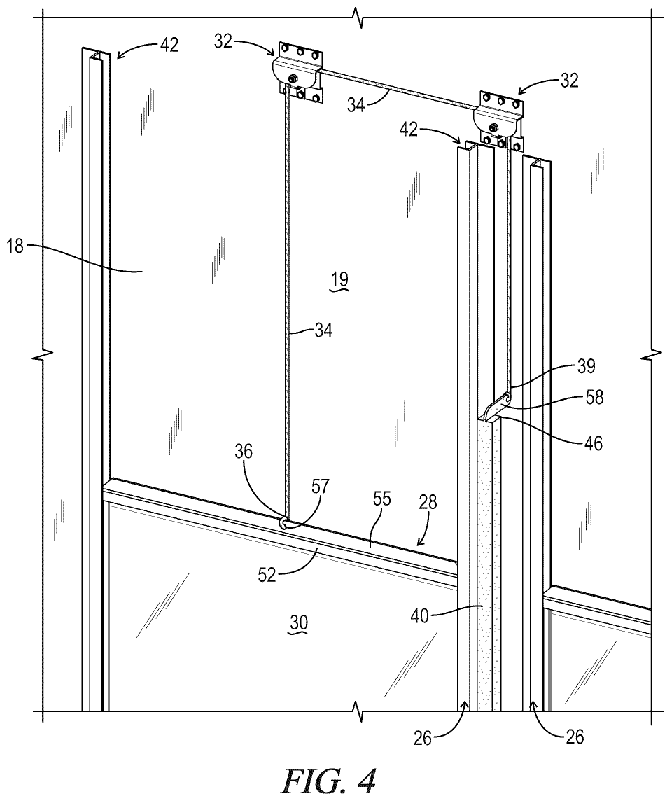

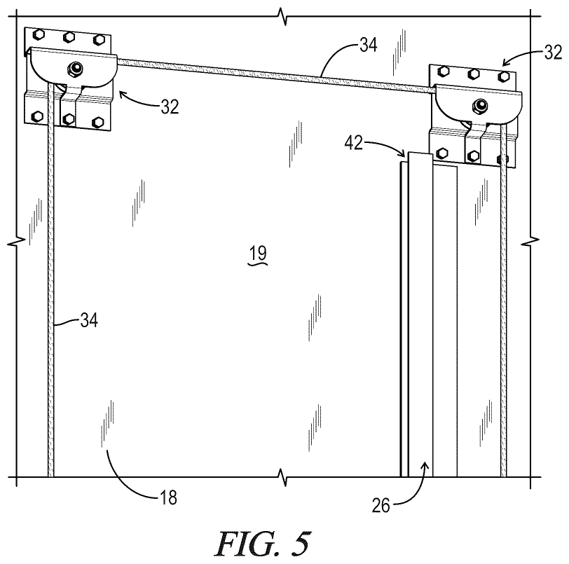

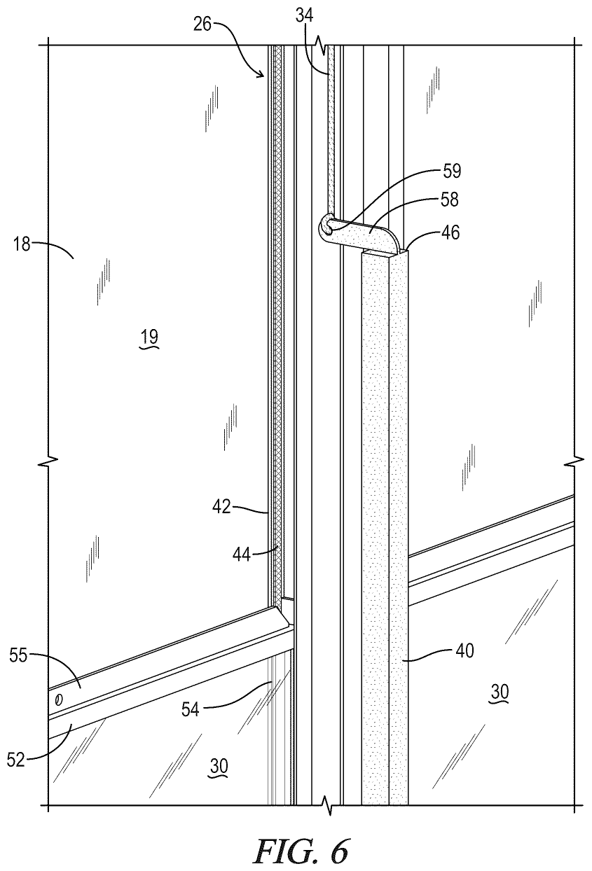

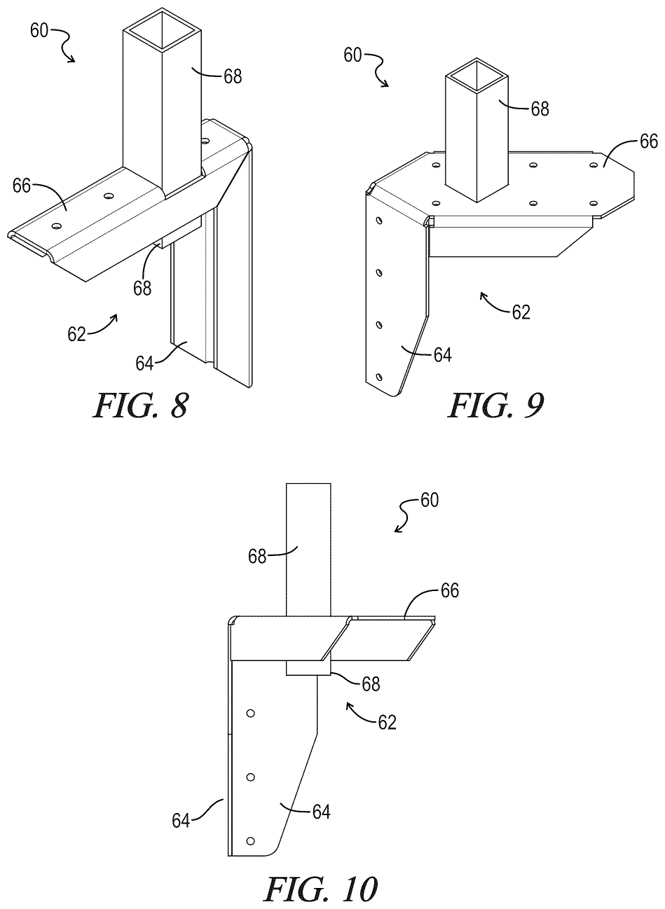

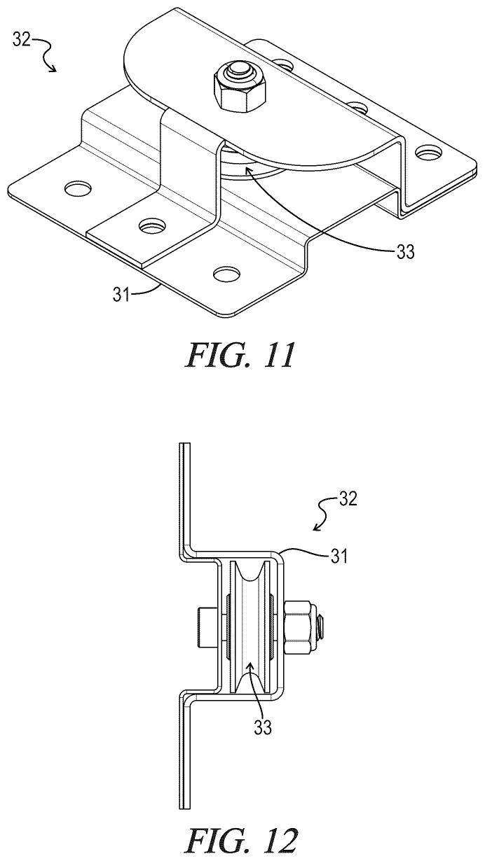

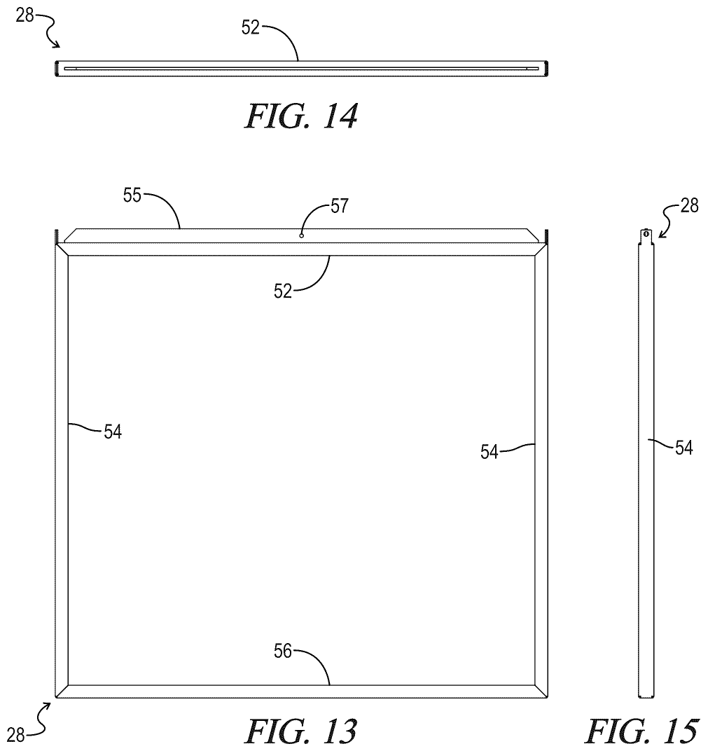

Referring now to FIGS. 3-15, each window 12 in the depicted embodiment of the hunting blind 10 generally includes a window frame 26, a window sash 28, a pane 30 of translucent or transparent material secured in the window sash 28, a pair of fixed pulleys 32, a sash cord 34, and a counterweight 40. The window frame 26 is connected to a wall panel 18 above the shelf 22 such that the shelf 22 extends horizontally below the window frame 26. Put differently, the shelf 22 is underneath the window frame 26. The window frame 26 is secured to an interior surface 19 of the wall panel 18 at an aperture or cutout 38 defined through the wall panel 18. In some embodiments, the window frame 26 can be secured to the wall panel 18 inside the aperture or cutout 38 such that the window frame 26 penetrates the wall panel 18.

The window frame 26 includes a pair of laterally spaced, vertical tracks 42. The tracks 42 are mounted to an inside surface of the wall panel defined by the aperture or cutout 38. A strip of material 44 configured to dampen vibration and absorb sound (e.g., felt, plastic) is secured in each track 42. The window sash 28 is slidably received in the tracks 42 of the window frame 26. The pair of tracks 42 restrict movement of the window sash 28 to movement along a single vertical axis 35. The strips of material 44 in the tracks 42 dampen vibration and absorb sound resulting from movement of the window sash 28 in the pair of tracks 42 during opening and closing of the window 12.

In the depicted embodiment, each window sash 28 includes a top rail 52, left and right side rails 54, and a bottom rail 56 which collectively encase the pane 30. A thin upwardly protruding rib 55 extends along the length of the top rail 52. A hole 57 is formed in the middle of the length of the rib 55. The side rails 54 ride in the tracks 42 on the window frame 26. The side rails 54 and tracks 42 are sized so that the side rails 54 are not visible from outside of the blind 10 when the window sash 28 is raised or lowered in the window frame 26. The window sash 28 is vertically sized to space the top rail 52 above the aperture 38 when the window 12 is closed so that the top rail 52 is not visible from outside of the blind 10 at any time.

In alternate embodiments, the bottom rail 56 can be omitted and the pane 30 can be secured to one or more of the top rail 52 and side rails 54. This eliminates the only portion of the inconspicuously operable window system 12 that may be visible to game during operation and movement of the window sash 28, thereby making such windows completely imperceptible to game. In some embodiments, each window sash 28 can include one or more rollers coupled to the top 52, sides 54, and/or bottom 56 rails to assist the window sash 28 in translating within the tracks 42. In some embodiments, a strip of material 44 configured to dampen vibration and absorb sound (e.g., felt, plastic) can be secured to each side rail 54 instead of the tracks 42.

The pane 30 secured in the window sash 28 can be formed from any clear or translucent material, including but not limited to glass, acrylic, and polycarbonate. In some embodiments, the pane 30 can be formed from two-way glass so that an exterior surface of the pane 30 facing game is reflective while the interior surface of the pane 30 facing the hunter is transparent. In some embodiments, the clear or translucent material can be tinted to reduce the transmission of UV light through the pane 30. In some embodiments, the pane 30 can include a single or a double layer of the material.

Each pulley 32 includes a bracket 31 and a rotating wheel 33 secured within the bracket 31. Each bracket 31 is secured to the wall panel 18. The pulleys 32 are laterally spaced and secured to the wall panel 18 above (i.e., higher than) the window frame 26. One pulley 32 is secured to the wall directly over the window sash 28. The pulley 32 directly over the window sash 28 is secured to the wall panel 18 directly above the approximate middle of the window sash 28 so as to provide a smooth and even upward pull against the window sash 28 during opening. The other pulley 32 is secured to the wall directly over the counterweight 40. In alternate embodiments, the windows 12 can include only one pulley 18 or three or more pulleys 18 mounted to the wall panel 18 and/or the ceiling of the enclosure. In some embodiments, one or more pulleys 32 may be movable.

The sash cord 34 has a first end 36 and a second end 39. The sash cord 34 is wound around the pulleys 32. The first end 36 of the sash cord 34 is connected the middle of the rib 55 on the top rail 52 of the window sash 28 at the hole 57. The second end 39 of the sash cord 34 is connected to the counterweight 40. The sash cord 34 extends upwardly from the window sash 28, around the two pulleys 32, and downwardly to the counterweight 40.

The counterweight 40 has a top 46 with a cord connection tab in the form of an elbow joint 58 to which the second end 39 of the sash cord 34 is connected and a bottom 48 that extends below the shelf 22. The second end 39 of the sash cord 34 can be connected to the elbow joint 58 at a hole 59. The elbow joint 58 extends transversely from the top 46 of the counterweight 40 toward the wall panel 18. The counterweight 40 has an elongated body that extends through the shelf 22. Aside from the small portion of the counterweight 40 that extends through the thickness of the shelf 22 and the mounting bracket 60 described below, the counterweight 40 is exposed (i.e., not embedded in the wall panel 18 or window frame 26) so as to allow the hunter 25 to grab the counterweight 40 underneath the shelf 22 in order to manually open and close the window 12. The counterweight 40 can be formed from any desired material, including metal, and can include heavy weights disposed within the elongated body (not shown) so as to give the counterweight 40 sufficient mass to counterbalance the window sash 28 and pane 30.

Operation of the window 12 is achieved by manually lowering the counterweight 40 to raise (i.e., open) the window sash 28 and raising the counterweight 40 to lower (i.e., close) the window sash 28. The counterweight 40 will accordingly pull downwardly on or provide slack to the sash cord 34, which being guided by the pulleys 32, will either lift the window sash 28 upwardly (as the counterweight 40 is moved downwardly) or allow gravity to pull the window sash 28 downwardly (as the counterweight 40 is moved upwardly). The counterweight 40 is configured to be manually movable down and up to respectively raise and lower the window sash 28 in the window frame 26 while movement of the hunter during operation of the counterweight 40 is substantially concealed from game 4, 6 to which the window 12 is visible, including game 4, 6 visible to the hunter 25 through the pane 30. As best shown in FIG. 2, inconspicuous operation of each window 12 generally requires simply that the hunter 25 seated inside the enclosure grab an exposed portion of the counterweight 40 at a location underneath the shelf 22 (e.g., at or near the bottom 48) and lower (i.e., pull down) or raise (i.e., push up) the counterweight 40 to respectively raise or lower the window sash 28 a desired amount. Manual operation of the counterweight 40 from a position below (i.e., lower than) the window frame 26 and underneath the shelf 22 ensures that movement of the hunter's arm and hand is out of sight and hidden from game 4, 6 looking toward the blind 10 regardless of the relative vertical viewpoint of the game. Put different, hunter movement is hidden even from game having a viewpoint above the hunter and very close to the blind 10, including tall land-based game 4 such as elk and moose, and airborne game 6 such as ducks and geese.

Additionally, since the window frame 26 and window sash 28 are mounted on the inside surface of the wall panel 18, no movement of the window sash 28 (except for the bottom rail 56, if present) is visible from the outside of the hunting blind 10. In other words, the movement of the window sash top rail 52 and side rails 54 are hidden from view (along with the sash cord 34, pulleys 32, and counterweight 40). Furthermore, the plastic-or felt-lined tracks significantly reduce the sound of the sliding window sash 28 such that the game 4, 6 cannot see or hear the window(s) 12 being opened and closed by the hunter 25 from within the hunting blind 10. Therefore, the window system 12 allows the hunter to inconspicuously and silently open and close the window(s) 12 without alerting game to his or her presence.

To ensure that movement of the counterweight 40 is as inconspicuous as possible, the counterweight 40 is mounted to the shelf 22 by a unique mounting bracket 60. The mounting bracket 60 rigidly connects the shelf 22 to the wall panel 18 and slidably mounts the counterweight 40 to the shelf such that the counterweight 40 is slidable though the mounting bracket 60 relative to the shelf 22. The mounting bracket 60 includes an angle brace 62 having first and second sections 64, 66, and a guide tube 68. The counterweight 40 is slidable through the guide tube 68. As such, the counterweight 40 is slidable though the mounting bracket 60 and the shelf 22. The mounting bracket 60 spaces the counterweight 40 from the wall panel 18. The first section 64 is connected to the wall panel 18 by a plurality of fasteners (not shown). The second section 66 is connected to the shelf 22 by a plurality of fasteners (not shown). The guide tube 68 is on the second section 66 of the angle brace 62. The guide tube 68 extends perpendicular from the second section 66 of the angle brace 62 and through a hole in the shelf 22. This arrangement stabilizes the counterweight 40 and ensures that its movement is constricted, like the window sash 28, to vertical movement along a single vertical axis. The guide tube 68 extends through the second section 66 of the angle brace 62 so as to permit the counterweight 40 to likewise slide up and down through the second section 66 of the angle brace 62.

The guide tube 68 and the counterweight 40 have corresponding square cross sections in order to prevent undesirable rotation of the counterweight 40 inside the guide tube 68, which could foul the pulley system by twisting the sash cord 34 out of the wheels 33. In other embodiments, the guide tube 68 and the counterweight 40 can share another non-circular cross section. The guide tube 68 can also be configured to apply a friction force to the counterweight 40 sufficient to arrest movement of the counterweight 40 and thereby the window sash 28 when manual operation of the counterweight 40 is ceased and thereby prevent the counterweight 40 from undesirably bobbing up and down in the guide tube 68 when the counterweight is released by a hunter. For this reason, the guide tube 68 is sized to closely receive the counterweight 40. The guide tube 68 can also be lined with a material configured to dampen vibration and absorb sound, such as felt or a plastic sleeve 71, so as to eliminate any sound made by the counterweight sliding through the guide tube 68. In alternate embodiments, a length of the counterweight 40 that passes through the guide tube 68 during opening and closing of the window 12 can be lined with the material.

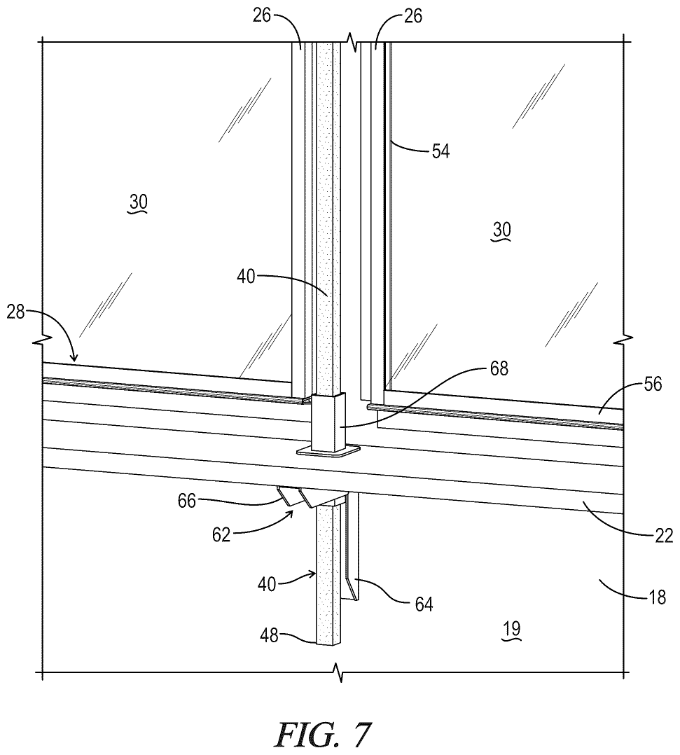

The friction between the counterweight 40 and guide tube 68 serve as a mechanical stop that causes the window sash 28 to remain stationary in any given position due to the counterbalancing weight of the counterweight. As such, the window sash 28 will not move up or down in the window frame 26 unless and until the hunter manually raises or lowers the counterweight 40. The counterweight 40 is sized so that its bottom 48 remains below the guide tube 68 and the shelf 22 throughout the full range of motion of the window sash 28, including when the window 12 is closed (see FIG. 7).

In other embodiments, the mounting bracket 60 can be configured to mount the counterweight 40 to a corner between adjacent wall panels 18 (see FIGS. 9-10). In such embodiments, the mounting bracket 60 can have two first sections 64 which can be connected to the adjacent wall panels 18 by a plurality of fasteners (not shown).

Although embodiments of the present invention have been described in detail, it will be understood by those skilled in the art that various modifications can be made therein without departing from the spirit and scope of the invention as set forth in the appended claims. For example, although the inconspicuously operable windows 12 of the hunting blind 10 exemplified above are depicted and described as being vertically operable, windows 12 within the scope of the present invention which slide laterally open and closed can also be formed using the apparatus components and principles disclosed herein.

Additionally, it is contemplated that a shelf 22 may be unnecessary to achieve the desired degree of concealment in some hunting applications. As such, it is to be understood that in some embodiments not shown herein, hunting blinds formed in accordance with the principles of the present invention can be constructed without a shelf 22. In such hunting blinds, the mounting bracket 60 alone can be used without the shelf 22 to securely and slidably mount the counterweight 40 to the wall panel 18 such that the counterweight 40 is manually slidable down and up through the guide tube 68 to respectively raise and lower the window sash 28 in the window frame 26 while movement of the hunter 25 during operation of the counterweight 40 is substantially concealed from game.

This written description uses examples to disclose the invention and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

It will be understood that the particular embodiments described herein are shown by way of illustration and not as limitations of the invention. The principal features of this invention may be employed in various embodiments without departing from the scope of the invention. Those of ordinary skill in the art will recognize numerous equivalents to the specific apparatus and methods described herein. Such equivalents are considered to be within the scope of this invention and are covered by the claims.

All of the compositions and/or methods disclosed and claimed herein may be made and/or executed without undue experimentation in light of the present disclosure. While the compositions and methods of this invention have been described in terms of the embodiments included herein, it will be apparent to those of ordinary skill in the art that variations may be applied to the compositions and/or methods and in the steps or in the sequence of steps of the method described herein without departing from the concept, spirit, and scope of the invention. All such similar substitutes and modifications apparent to those skilled in the art are deemed to be within the spirit, scope, and concept of the invention as defined by the appended claims.

Thus, although there have been described particular embodiments of the present invention, it is not intended that such references be construed as limitations upon the scope of this invention except as set forth in the following claims.

What is claimed is:

1. A hunting blind, comprising:
a wall panel;
a shelf connected to the wall panel;
a window frame on the wall panel above the shelf;
a window sash movably received in the window frame;
at least one pulley connected to the wall panel;
a sash cord disposed about the at least one pulley, the sash cord having a first end and a second end, the first end connected to the window sash; and
a counterweight having a top connected to the second end of the sash cord and a bottom extending below the shelf, the counterweight configured to be manually operable from underneath the shelf to move the window sash in the window frame while user movement during operation of the counterweight is substantially concealed from game.

2. The hunting blind of claim 1, wherein the counterweight extends through the shelf.

3. The hunting blind of claim 1, wherein the bottom of the counterweight extends underneath the shelf.

4. The hunting blind of claim 1, wherein the counterweight is manually movable up and down from underneath the shelf to respectively lower and raise the window sash in the window frame.

5. The hunting blind of claim 1, wherein:
the window frame defines a pair of tracks;
the window sash is slidably received in the pair of tracks; and
the pair of tracks restrict movement of the window sash to movement along a single axis.

6. The hunting blind of claim 5, further comprising:
a strip of material secured to each track of the pair of tracks, the material configured to dampen vibration and absorb sound resulting from movement of the window sash in the pair of tracks.

7. The hunting blind of claim 1, wherein the first end of the sash cord is connected to a top rail of the window sash.

8. The hunting blind of claim 7, wherein:
the top rail of the window sash includes a thin rib extending along a length thereof; and
the first end of the sash cord is connected to a middle of the rib.

9. The hunting blind of claim 1, further comprising:
a mounting bracket rigidly connecting the shelf to the wall panel and slidably mounting the counterweight to the shelf such that the counterweight is slidable though the mounting bracket relative to the shelf.

10. The hunting blind of claim 9, wherein:
the mounting bracket includes a guide tube extending through the shelf; and
the counterweight is slidable through the guide tube.

11. The hunting blind of claim 10, wherein:
the mounting bracket includes an angle brace comprising a first section connected to the wall panel and a second section connected to the shelf; and
the guide tube is on the second section of the angle brace.

12. The hunting blind of claim 10, wherein:
the guide tube is sized to closely receive the counterweight; and
the guide tube and the counterweight have corresponding non-circular cross sections.

13. The hunting blind of claim 10, wherein the guide tube is configured to exert a frictional force against the counterweight sufficient to arrest movement of the counterweight and thereby the window sash when manual operation of the counterweight is ceased.

14. The hunting blind of claim 10, wherein:
the guide tube is sized to closely receive the counterweight; and
the guide tube is at least partially lined with felt or a plastic sleeve.

15. The hunting blind of claim 1, wherein the at least one pulley is connected to the wall panel above the window frame.

16. The hunting blind of claim 15, wherein the at least one pulley is two laterally spaced pulleys.

17. A hunting blind, comprising:
a wall panel;
a shelf connected to the wall;
a window frame connected to the wall above the shelf;
a vertically movable window sash slidably received in the window frame;
a pane of translucent or transparent material secured in the window sash;
at least one pulley connected to the wall above the window frame;
a sash cord disposed about the at least one pulley, the sash cord having a first end and a second end, the first end connected to the window sash; and
a counterweight extending through the shelf, the counterweight having a top connected to the second end of the sash cord and a bottom extending underneath the shelf, the counterweight configured to be manually movable down and up to respectively raise and lower the window sash in the window frame while user movement during operation of the counterweight is substantially concealed from game visible to the user through the pane.

18. The hunting blind of claim 17, further comprising:
a mounting bracket rigidly connecting the shelf to the wall panel and slidably mounting the counterweight to the shelf such that the counterweight is slidable though the mounting bracket and the shelf.

19. The hunting blind of claim 18, wherein:
the mounting bracket includes a guide tube extending through the shelf;
the counterweight is slidable through the guide tube;
the guide tube and the counterweight have corresponding non-circular cross sections; and
the guide tube is configured to exert a frictional force against the counterweight sufficient to arrest movement of the counterweight and thereby the window sash when manual operation of the counterweight is ceased upon release of the counterweight by a user.

20. A hunting blind, comprising:
a wall panel;
a guide tube connected to the wall panel;
a window frame connected to the wall panel proximate the guide tube;
a vertically movable window sash slidably received in the window frame;
a pair of laterally spaced pulleys connected to the wall above the window frame;
a sash cord disposed about the pair of laterally spaced pulleys, the sash cord having a first end and a second end, the first end connected to the window sash; and
a counterweight slidably received in the guide tube, the counterweight having a top connected to the second end of the sash cord and a bottom extending underneath the guide tube, the counterweight configured to be manually slidable down and up through the guide tube to respectively raise and lower the window sash in the window frame while user movement during operation of the counterweight is substantially concealed from game.
